(19) United States
(12) Patent Application Publication
(10) Pub. No.: US 2012/0240097 A1
(43) Pub. Date: Sep. 20, 2012

(54) METHOD OF PROVIDING SOFTWARE DEVELOPMENT SERVICES

(76) Inventor: Ralph Saunders, Springfield, VA (US)

(21) Appl. No.: 13/486,117

(22) Filed: Jun. 1, 2012

Related U.S. Application Data
(63) Continuation-in-part of application No. 11/702,196, filed on Feb. 5, 2007.
(60) Provisional application No. 60/765,204, filed on Feb. 6, 2006.

(51) Int. Cl. G06F 9/44

(52) U.S. Cl. 717/103

(57) ABSTRACT

A method for enabling a software developer to provide software development services to an end user. The software developer has a website and other network accessible computers that the end user can access to define for the software developer the nature of the custom source code or software to be developed for the end user. Based on the input by the end user, the software developer then develops, compiles and installs on one of its own computers the defined custom software or source code for review and testing online by the end user. The developed custom software or source code is made available for downloading onto the end user's computer once the end user has approved it online after review and testing. The custom software or source code is “work for hire” and is owned by the end user who has exclusive intellectual property rights therein.

### CROSS REFERENCE TO RELATED APPLICATIONS

This application is a continuation-in-part of U.S. patent application Ser. No. 11/702,196, filed Feb. 5, 2007, pending, which claims the benefit and priority of Provisional Patent Application No. 60/765,204 filed on Feb. 6, 2006, the entire contents of each of which are hereby incorporated by reference in this application.

### BACKGROUND OF THE INVENTION

1. Field of the Invention

The present invention relates to a method of providing software development services to an end user and, more particularly, to such a method wherein the services can be provided online to the end user at a computer work station or the like.

2. Description of the Background Art

Up to the present time, software development services have been provided to customers using one, or a combination of, two methods. The first method is to provide temporary software development personnel who physically reside at a customer's office in order to create the source code, build scripts and other files needed to compile, run and test and otherwise use the software, organized into what is called a source code tree. These software development personnel determine the requirements that are needed to create the desired software, and other necessary files, through several different methods, including but not limited to, face to face meetings with the customer, through phone conversations with the customer and through emails exchanged with the customer. The software development personnel then use the information contained in those requirements to create a source code that, when compiled and run, will fulfill those requirements.

The second method is to provide software development personnel who do not physically reside at the customer's office, but instead physically reside at another location that is separate from any facilities owned or leased by the customer in order to create the desired software. As in the previous method, software requirements are gathered using several methods, including but not limited to, face to face meetings with the customer, phone conversations with the customer and through emails exchanged with the customer. Once the requirements are gathered, the software developer uses the information in those requirements to create the desired source code.

With each of these methods, at the end of the software development process, the source code is compiled and the tests are run to make sure that the source code meets the requirements that were collected at the beginning of the process.

Both of these processes add risk to the software development process because it takes many months before the customer knows if the software that is being developed will work as desired, and if it does not work, the time spent on developing that software will be completely wasted and will cause the project to be late, and could cause the project to fail altogether. In addition, if the customer is required to pay for the software development as it progresses, there is additional risk for the customer because in addition to losing valuable development time, the customer will also have incurred a significant cost which it may not be able to recover from the software developer.

The new and improved method of the present invention eliminates the above identified risk and greatly reduces the cost associated with developing software by reducing the amount of time it takes to create a working version of the desired software and other necessary files from as long as weeks, months and years, to as little as a day or less, once the requirements for that software have been defined.

Referring to another aspect of the method of the present invention, there are four different approaches a developer can use to create new software:
1) To create design that calls for using custom source code, created by a developer specifically for a given end user and either licensed to that user or developed as “work for hire” for that user, to implement the business logic, services and other functionality identified in the requirements provided by that end user;
2) To create a design that calls for using custom source code created by a developer and either licensed to that user or developed as “work for hire” for that user to implement the business logic identified in the requirements along with using preexisting software frameworks to provide services and other functionality called out in the requirements provided by the end user;
3) To use preexisting software engineering modules and, either no custom source code or custom source code that is licensed for use by the customer, to implement the business logic, services and other functionality identified in the end user's requirements (e.g., see Bellagamba, U.S. Publ. 2002/0188927); or
4) To use preexisting software applications and , either no custom source code or custom source code that is licensed for use by the customer, to implement/provide the business logic, services and other functionality identified in the end user's requirements (e.g., see Bilange, U.S. Publ. 2004/0093595).

Each of these approaches can be used to produce a given software product for an end user, but each of these approaches will provide the end user with a different level of rights to the intellectual property contained in that software product. The reason for this is due to the differences between how the law views intellectual property rights with respect to custom source code, preexisting software frameworks, preexisting software engineering modules and preexisting software applications. Preexisting software engineering modules and preexisting software applications are either licensed for use by the end user or they are in the public domain and available for anyone to use and provide no intellectual property rights to the end user. The same is true for preexisting software frameworks, but these frameworks do not implement any business logic and only provide generic services to any application that uses them. Custom source code, on the other hand, is the intellectual property of the developer of that source code unless the source code was developed under contract as a “work for hire”. Source code that was developed as “work for hire”, becomes the exclusive property of the customer (i.e. end user), providing that customer with full intellectual property rights to that custom source code.

In addition, licensed software may, or may not, allow the end user access to the source code that was used to create the software component. If the user is not allowed access to the source code, it will not be able to use the source code to trouble shoot problems that might occur with the software product long after the development of the software product has ended. Without access to the source code, the end user will also not be able to enhance its software product by adding to, or changing, the source code that was used to create the software engineering module, nor will it be able to fix bugs in the software engineering module that adversely affect the developed software. Instead, the end user will be reliant on the provider/owner of the software engineering module to make the enhancement or bug fix that the end user needs. Even if the user has access to the source code, the license associated with the source code may impose restrictions on the use and modification of that software, a condition that would not exist if the business logic the engineering module implements were implemented using custom source code that was developed as “work for hire”, instead of being implemented using preexisting software engineering modules and/or custom source code that is licensed for use by the end user.

### SUMMARY OF THE INVENTION

In accordance with the method of the present invention, the software developer has a website and other network accessible computers that the user can access with a computer to define online the requirements for the source code or software that is to be developed for the user. The software developer then develops, compiles and installs the custom source code on one of its own computers for review and testing by the user. Once the user is satisfied with the custom source code that has been developed, it is charged for the software development services and the source code is made available for downloading onto the user's computer. The term “software developer” used herein is intended to cover any type of provider such as a computer program and/or human services. Accordingly, the custom source code is developed from a set of requirements specifically for the end user. Custom Source code is considered the exclusive intellectual property of the developer, unless the custom source code is developed under contract as “work for hire”, in which case the developed source code becomes the exclusive intellectual property of the end user for whom the source code was created. Because of this, the custom source code provides the end user full intellectual property rights with no restrictions of any kind, including restrictions associated with enhancing the software product that was built using the custom source code and restrictions associated with fixing any bugs that get discovered after the development process has ended.

A software product with business logic that was implemented using custom source code that the end user has exclusive intellectual property rights to is more valuable to that end user than a software product that was created using just licensed components, custom source code and/or public domain software.

### DETAILED DESCRIPTION OF THE INVENTION

### User Management and New Account Creation

The present method is adapted is to be used in a modern business environment and recognizes that software development services are often used by individuals on behalf of the company that they work for. As a result, the present method can include a user management function that manages “users” who are associated with a specific “customer”. By associating specific users with a specific customer, the system will be able to ensure that a customer's data can only be accessed by individuals the customer has authorized to access that data.

The first step in using the present method is for the new user to register as a customer by going to the web site of the software developer and selecting a “register new customer” function. The user then inputs the required information, including an initial password for the “master” user id that will be created, and the system creates a “pending customer” record. A contract for software development services that defines the source code to be developed as “work for hire” which is the exclusive property of the customer is then sent to the customer for review, signing and return. Upon receipt of the signed contract, the “pending customer” record is removed and a new customer account is created along with a user id that is associated with the new customer. This user id is the “master” user id for that customer account and the user is able to add, update, view and delete additional users who will be associated with the same customer that the “master” user id is associated with. In addition the “master” user can assign privileges to the additional users to control the functions they are allowed to perform on the behalf of the customer.

### Generating Source Code and Support Files

In order to create the desired custom source code, several “logical items” need to be combined or associated with each other. These items include e.g., business objects; sources for retrieving and saving data, such as databases, SOAP servers, custom built remote servers, etc. (a.k.a. data stores); application specific business logic and implementation specific information. The software developer provides editors and other tools that allow the user to add, update, delete, view and otherwise manipulate these “logical items”.

Once a customer account has been created and users have been assigned to it, the users can then log on and, depending on the privileges assigned to them, they can define requirements for application logic, business objects and different data sources and save them.

When a user desires that the software developer create a custom source code, and optional supporting files, in order to implement previously defined business logic, the user can use online the developer's “generate source code” functionality to accomplish this. This functionality allows the user to select the previously defined business logic it wishes to implement, associate the business objects that are manipulated by the business logic with a data source, and define implementation specific information including, but not limited to, software technologies to use when implementing the logic and version identifiers for third party software, into what is called a “build request”. The user is then able to submit the build request online and have the developer create the desired source code. The user will also be able to save the build request so that it can be retrieved later on by the user, optionally edited, and resubmitted to the developer. In addition, the user will be able to use the “generate source code” functionality without accessing any predefined “logical items” by simply creating them on the fly using the developer's editors.

### Verifying and Downloading the Generated Source Code

Once the desired custom source code is generated, the user, as appropriate based on the kind of source code that was generated, can compile, install and run the source code, compile the code and run the generated test code and test scripts, or visually inspect portions of the code on the developer's computer, for the purposes of verifying that the source code that was generated does in fact meet the requirements that were provided by the user at source code generation time.

When the user is satisfied with the generated custom source code it can be accepted at which time the system will charge the customer account that the user is associated with for the services rendered, package the software into an archive file and make that archive available for authorized users that are associated with the customer to download. The custom source code developed for the end user, unlike the licensed software components and the licensed custom source code used by others, is “work for hire” and is owned by the end user, giving that end user exclusive intellectual property rights in the software product. While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of enabling a software developer to provide software development services to an end user, wherein:
the software developer establishes a website and other network accessible computers that the end user can access to define for the software developer the nature of the custom source code or software to be developed for the end user;
based on the input by the end user, the software developer develops, compiles and installs on one of its own computers the defined custom software or source code as “work for hire” for review and testing online by the end user; and
the developed custom software or source code is made available for downloading onto the end user's computer for exclusive ownership and use by the end user who will have exclusive intellectual property rights in the custom software or source code once the end user has approved it online after review and testing.

2. The method of claim 1 wherein the end user first registers with the software developer to gain access to the website and other network accessible computers of the software developer.

3. The method of claim 1 wherein, when defining the software or source code to be developed, the end user identifies at least one of databases, SOAP servers, custom built remote servers, application specific business logic and/or implementation specific information.

4. The method of claim 1 wherein the website and other network accessible computers of the software developer enable the end user to save and amend its definition of the software or source code to be developed.

5. The method of claim 1 wherein the end user is charged for the software development services after it has approved the developed custom software or source code and before it is made available for downloading onto the end user's computer.

6. The method of claim 1 wherein the end user can identify other authorized users of the developed custom software or source code such that it can be downloaded onto the computers of the other authorized users.

7. The method of claim 2 wherein a contract for software development services that defines the source code to be developed as “work for hire” which is the exclusive property of the customer is sent to the end user after it registers with the software developer.
